(19) United States
(12) Patent Application Publication
(10) Pub. No.: US 2024/0421334 A1
(43) Pub. Date: Dec. 19, 2024

(54) APPARATUS AND METHOD FOR ASSEMBLING A CONDUCTOR ASSEMBLY FOR A PROTON EXCHANGE MEMBRANE FUEL CELL

(71) Applicant: GM GLOBAL TECHNOLOGY OPERATIONS LLC, Detroit, MI (US)

(72) Inventor: Swaminatha P. Kumaraguru, Rochester Hills, MI (US)

(73) Assignee: GM GLOBAL TECHNOLOGY OPERATIONS LLC, Detroit, MI (US)

(21) Appl. No.: 18/336,224

(22) Filed: Jun. 16, 2023

(51) Int. Cl. H01M 8/1069; H01M 8/1004; H01M 8/1027

(52) U.S. Cl. CPC H01M 8/1069; H01M 8/1004; H01M 8/1027; H01M 2300/0097

(57) ABSTRACT

An apparatus for assembling a conductor assembly for a PEM fuel cell includes an application module for applying first and second stripes of an adhesive onto a rolled-out segment of GDL material, wherein the first and second stripes run along respective first and second longitudinal edges of the GDL material defining an applied segment. A cutting module cuts the applied segment to form one or more cut segments each having a respective primary surface on which respective portions of the stripes are carried. A laminating module laminates a subgasket between two cut segments, wherein the subgasket has a window bounded by a window periphery, and the two cut segments are oriented with their primary surfaces facing and covering the window with their respective portions of the first and second stripes being in contact with the window periphery.

### INTRODUCTION

This disclosure relates to apparatuses and methods for assembling a conductor assembly for a proton exchange membrane which uses a gas diffusion layer material.

Fuel cells are electrochemical conversion devices that produce electrical energy by the oxidation and reduction, respectively, of hydrogen and oxygen. Exemplary fuel cells may comprise a membrane-electrode assembly (MEA), made up of a polymer electrolyte membrane (PEM) stacked with catalyst layers, gas diffusion layers (GDLs), micro-porous layers and subgaskets on opposed anode and cathode sides of the PEM. Several MEA layers stacked together with bipolar plates assembly would form a fuel cell stack.

In some configurations, the PEM fuel cell stack includes multiple conductor assemblies. These conductor assemblies are made from sheets of GDL material laminated to subgaskets, with the assemblies then stacked together to form a portion of the PEM fuel cell stack.

### SUMMARY

According to one embodiment, a conductor assembly for a proton exchange membrane fuel cell includes: (i) first and second cut segments of GDL material, wherein each of the first and second cut segments has a respective first surface, respective opposed first and second longitudinal edges, and respective first, second and third stripes of an adhesive material applied onto the respective first surface along a respective length of the respective first surface, wherein for each of the first and second cut segments the respective first stripe runs along and is proximate to the respective first longitudinal edge, the respective second stripe runs along and is proximate to the respective second longitudinal edge, and the respective third stripe runs between the respective first and second stripes; and (ii) a generally planar subgasket having a window therethrough bounded by a window periphery surrounding the window.

The generally planar subgasket is sandwiched between the first and second cut segments with the first and second cut segments oriented with their respective first surfaces facing and covering the window and with their respective first and second stripes being disposed in contact with the window periphery.

The first and second cut segments may be oriented such that the first, second and third stripes of one of the first and second cut segments are registered with the first, second and third stripes of the other of the first and second cut segments. For each of the first and second cut segments, the respective first, second and third stripes may be parallel with each other.

The respective third stripes of the first and second cut segments may be adhered to each other, and the respective first and second stripes of the first and second cut segments may be disposed in contact with less than an entirety of the window periphery.

The adhesive material may be an ionomer solution. For example, the ionomer solution may be a perfluorosulfonic acid polymer. Optionally, the ionomer solution may contain an electrically conductive additive therein.

According to another embodiment, a conductor assembly for a proton exchange membrane fuel cell includes: (i) first and second cut segments of GDL material, wherein each of the first and second cut segments has a respective first surface, respective opposed first and second longitudinal edges, and respective first and second stripes of an ionomer solution applied onto the respective first surface along a respective length of the respective first surface, wherein for each of the first and second cut segments the respective first stripe runs along and is proximate to the respective first longitudinal edge and the respective second stripe runs along and is proximate to the respective second longitudinal edge; and (ii) a generally planar subgasket having a window therethrough bounded by a window periphery surrounding the window. The generally planar subgasket is sandwiched between the first and second cut segments with the first and second cut segments oriented with their respective first surfaces facing and covering the window and with their respective first and second stripes being disposed in contact with the window periphery.

Each of the first and second cut segments may include a respective third stripe of the ionomer solution applied onto the respective first surface along the respective length of the respective first surface and running between the respective first and second stripes. The respective third stripes of the first and second cut segments may be self-adhered to each other.

The first and second cut segments may be oriented such that the first and second stripes of one of the first and second cut segments are registered with the first and second stripes of the other of the first and second cut segments. For each of the first and second cut segments, the respective first and second stripes may be parallel with each other.

The ionomer solution may be a perfluorosulfonic acid polymer, and the ionomer solution may contain an electrically conductive additive therein.

The respective first and second stripes of the first and second cut segments may be disposed in contact with less than an entirety of the window periphery. Additionally, each of the first and second cut segments may include one or more respective deposits of the ionomer solution on the respective first surface between the respective first and second stripes, wherein the one or more deposits on one of the first and second cut segments are registered with and self-adhered to the one or more deposits on the other of the first and second cut segments.

According to yet another embodiment, an apparatus for assembling a conductor assembly for a PEM fuel cell includes an application module, a cutting module and a laminating module. The application module is configured for applying first, second and third stripes of an adhesive material onto a first surface of a rolled out segment of GDL material along a length thereof, the rolled out segment having opposed first and second longitudinal edges, wherein the first stripe runs along and is proximate to the first longitudinal edge, the second stripe runs along and is proximate to the second longitudinal edge, and the third stripe runs between the first and second stripes, thereby defining an applied segment. The cutting module is configured for cutting the applied segment so as to form one or more cut segments each having a respective primary surface on which respective portions of the first, second and third stripes are carried. The laminating module is configured for laminating a generally planar subgasket between two of the cut segments, wherein the subgasket has a window therethrough bounded by a window periphery surrounding the window, and wherein the two cut segments are oriented with their respective primary surfaces facing and covering the window and with their respective portions of the first, second and third stripes being disposed in contact with the window periphery.

The apparatus may also include an unrolling module configured for unrolling a roll of the GDL material to provide the rolled out segment. In this arrangement, the unrolling module and the application module may be configured to cooperate with each other such that the unrolling and the applying are continuous and simultaneous with each other.

The apparatus may further include a trimming module configured for trimming each of the one or more cut segments to provide one or more overall outer dimensions and/or one or more feature dimensions for each of the one or more cut segments.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic process flow diagram illustrating a method and apparatus for assembling a conductor assembly according to a customary approach.

FIG. 2 is a schematic process flow diagram illustrating methods and apparatuses for assembling a conductor assembly according to the present disclosure, according to a first method embodiment, a second method embodiment, a third apparatus embodiment and a fourth apparatus embodiment.

FIGS. 3-4 are flowcharts of the first and second method embodiments, respectively.

FIG. 5 is a schematic perspective view of an applied segment having first, second and third stripes thereon as produced by the first method embodiment and by the third apparatus embodiment.

FIGS. 6-11 are various close-up views of the dotted rectangle area of FIG. 5.

FIG. 12 is a schematic perspective view of an applied segment having first lateral, second lateral, medial, first mesomedial and second mesomedial stripes thereon as produced by the second method embodiment and by the fourth apparatus embodiment.

FIG. 13 is a schematic perspective view of an applied segment having first lateral, second lateral, first paramedial, second paramedial, first mesomedial and second mesomedial stripes thereon as produced by the second method embodiment and by the fourth apparatus embodiment.

FIG. 14 is a close-up view of the dotted oval area of FIG. 13.

FIG. 15 is an exploded schematic side view of a subgasket and two cut segments prior to lamination.

FIG. 16 is an assembled schematic side view of the subgasket and two cut segments of FIG. 15 after lamination, thus forming a completed conductor assembly.

FIG. 17 is a schematic plan view of a completed conductor assembly according to one embodiment.

FIG. 18 is a close-up schematic section view of the completed conductor assembly of FIG. 17 as viewed along line A-A.

FIGS. 19-20 are block diagrams of the third and fourth apparatus embodiments, respectively.

### DETAILED DESCRIPTION

Referring now to the drawings, wherein like numerals indicate like parts in the several views, various embodiments of an apparatus and method for assembling a conductor assembly 10 for a PEM fuel cell are shown and described herein. More specifically, the drawings illustrate a first method embodiment 100, a second method embodiment 200, a third apparatus embodiment 180 and a fourth apparatus embodiment 280, wherein the first and third embodiments 100, 180 are related to each other, and the second and fourth embodiments 200, 280 are related to each other.

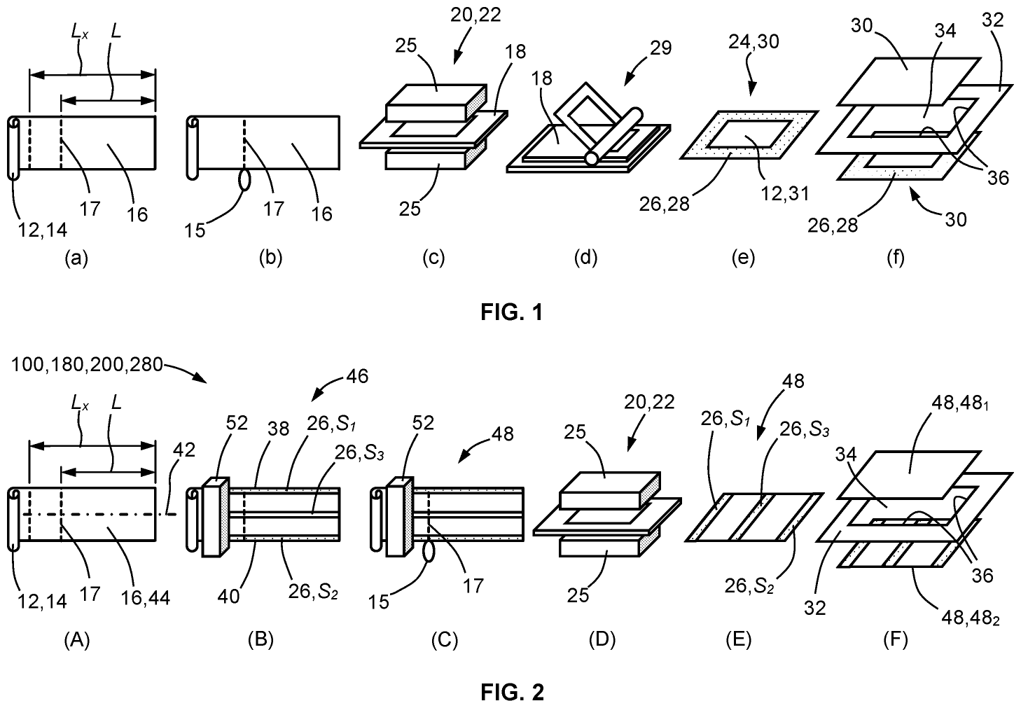

FIG. 1 shows a schematic process flow diagram illustrating a method and apparatus for assembling a conductor assembly according to a customary approach. Note that the process flow includes a number of sequential steps in the method, labeled from “(a)” to “(f)”; similarly, these steps may be implemented by using suitable apparatus stations, sub-systems, tools or components, which are also illustrated as part of the process flow.

At step/station “(a)”, GDL material 12 (which is typically provided in roll form 14) is unrolled at least along a minimum length L so as to present a rolled out segment 16 of the GDL material 12. Optionally, the roll 14 of GDL material 12 may be unrolled to a length Lx which is longer than the minimum length L that is needed.

At step/station “(b)”, the rolled out segment 16 is cut or slit from the roll 14 of GDL material 12, thereby providing a cut segment 18 of GDL material 12. This may be performed using a knife, scissors or other suitable cutting tool 15, with the cut or slit running along a score line 17 which runs perpendicular to the rolled out length L of the GDL material 12.

At step/station “(c)”, the cut segment 18 is trimmed to provide one or more overall outer dimensions 20 and/or one or more feature dimensions 22 for the cut segment 18, thereby resulting in a trimmed segment 24. The overall outer dimensions 20 may include an overall length, an overall width, etc., and the feature dimensions 22 may include dimensions for various holes, slots, pockets, contours, or other features that are cut into the cut segment 18, thus creating the trimmed segment 24. The overall outer dimensions 20 and/or one or more feature dimensions 22 may be cut using a cutting die 25 and/or other suitable tools.

At step/station “(d)”, an adhesive material 26 is screen-printed onto one side of the trimmed segment 24 around the entire outer periphery 28 of the trimmed segment 24 using a screen-printing device 29, thereby forming a screen-printed segment 30.

At step/station “(e)”, the screen-printed segment 30 is shown, which results from the screen-printing process of the previous step. Here, it can be seen that the screen-printed segment 30 has adhesive material 26 screen-printed around the whole outer periphery 28 of the trimmed segment 24. For example, a segment 24, 30 which is rectangular in overall shape as shown here may have a window-frame-like border of adhesive material 26 deposited around the entire periphery 28 of the trimmed and screen-printed segment 24, 30, with the window-frame-like border of adhesive material 26 bounding and defining an interior rectangular region 31 of GDL material 12 which has no adhesive material 26 thereon.

Finally, at step/station “(f)”, a generally planar (e.g., flat) subgasket 32 is sandwiched and laminated between two of the screen-printed segments 30. The subgasket 32 has a window 34 (such as a rectangular aperture) formed therethrough, with the window 34 being defined and bounded by a window periphery or peripheral region 36 which surrounds the entirety of the window 34. The two screen-printed segments 30 are oriented such that their surfaces having the adhesive material 26 screen-printed thereon are facing each other and also facing and covering the window 34. Each of the two screen-printed segments 30 may be centered with respect to window 34, such that their respective screen-printed outer peripheries 28 are disposed in contact with the window periphery 36. In this arrangement, the adhesive material 26 adheres each of the two screen-printed segments 30 of GDL material 12 to the subgasket 32, with the adhesive material 26 extending about the entire perimeter of each screen-printed segment 30 and about the entire perimeter of the window periphery 36, thus providing a completed conductor assembly according to the customary approach.

In contrast, FIG. 2 shows a schematic process flow diagram illustrating methods and apparatuses for assembling a conductor assembly 10 according to the present disclosure. Here, a first method embodiment 100, a second method embodiment 200, a third apparatus embodiment 180 and a fourth apparatus embodiment 280 are illustrated. Note that the process flow includes a number of sequential steps/stations, labeled from “(A)” to “(F)”, representing the steps of the first and second methods 100, 200, as well as related stations, sub-systems, tools or components of the third and fourth apparatuses 180, 280 for forming and assembling the conductor assembly 10.

At step/station “(A)”, a roll of GDL material 12 is unrolled to provide a rolled out segment 16 of the GDL material 12 having a desired length L and opposed first and second longitudinal edges 38, 40 and a longitudinal centerline 42 running parallel with and between the first and second longitudinal edges 38, 40.

At step/station “(B)”, first, second and third stripes S₁, S₂, S₃ of an adhesive material 26 are applied onto a first surface 44 of the rolled out segment 16 along the unrolled length L. Here, the first stripe S₁ runs along and is proximate to the first longitudinal edge 38, the second stripe S₂ runs along and is proximate to the second longitudinal edge 40, and the third stripe S₃ runs parallel with and between the first and second stripes S₁, S₂ (e.g., along and proximate to the longitudinal centerline 42), thereby defining an applied segment 46. The adhesive material 26 may be applied to the first surface 44 using a slot die 52, and may include an ionomer, such as a perfluorosulfonic acid polymer, which may also be utilized in other parts of the manufacturing process for conductor assemblies 10.

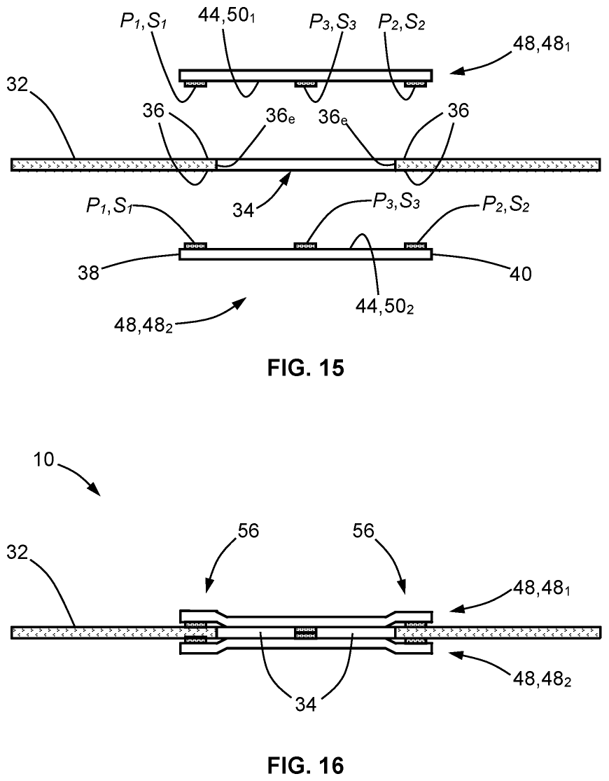

At step/station “(C)”, the applied segment 46 is cut so as to form one or more cut segments 48—such as a first cut segment 48₁ and a second cut segment 48₂, as shown in FIGS. 15-16—with each cut segment 48 having a respective primary surface 50 on which respective portions P₁, P₂, P₃ of the first, second and third stripes S₁, S₂, S₃ are carried. That is, if two cut segments 48₁, 48₂ are cut simultaneously at this step/station, then the first cut segment 48₁ has a first primary surface 50₁ which carries portions P₁, P₂, P₃ of the first, second and third stripes S₁, S₂, S₃; similarly, the second cut segment 48₂ has a first primary surface 50₂ which also carries portions P₁, P₂, P₃ of the first, second and third stripes S₁, S₂, S₃. (These stripes S₁, S₂, S₃ and their respective portions P₁, P₂, P₃ are described in greater detail below.) Note that in some configurations, if two or more cut segments 48 are produced by the cutting at step/station “(C)”, these cut segments 48 may be identical to one another, and thus may be interchangeable with other cut segments 48 in subsequent steps/stations.

At step/station “(D)”, an optional step or operation is performed in which each cut segment 48 is trimmed to provide one or more overall outer dimensions 20 and/or one or more feature dimensions 22 for each segment 48. This step or operation of trimming each cut segment 48 may also be performed as part of the cutting step/station “(C)” above; for example, the cutting step/station may also form one or more overall outer dimensions 20 and/or one or more feature dimensions 22 when the applied segment 46 is being cut to form the one or more cut segments 48.

At step/station “(E)”, a cut segment 48 is shown, which may be a trimmed cut segment resulting from step/station “(D)” (if step/station “(D)” is implemented), or it may be an untrimmed cut segment resulting from step/station “(C)” (if step/station “(D)” is skipped or omitted). Note the cut segment 48 is shown here without a subscript, as it may represent either or both of the first and second cut segments 48₁, 48₂ if two segments 48 are cut at the same time, or it may represent any of three of more cut segments 48 if three or more are cut at the same time. In this step/station, two cut segments 48 may be optionally positioned and oriented in preparation for the next step/station. For example, as illustrated in FIG. 15, a first of the two cut segments 48₁ may be positioned with its primary surface 50 (and the segment's portions P₁, P₂, P₃ of the first, second and third stripes S₁, S₂, S₃) facing downward, and a second of the two cut segments 48₂ may be positioned with its primary surface 50 (and this segment's portions P₁, P₂, P₃ of the first, second and third stripes S₁, S₂, S₃) facing upward, with the first cut segment 48₁ hovering above the second cut segment 48₂ such that the respective portions P₁, P₂, P₃ of the first, second and third stripes S₁, S₂, S₃ of the two cut segments 48₁, 48₂ are registered (i.e., vertically aligned) with each other.

Finally, at step/station “(F)”, a generally planar subgasket 32 is sandwiched and laminated between two cut segments 48. The subgasket 32 has a window 34 therethrough bounded by a window periphery 36 surrounding the window 34. The two cut segments 48 are oriented with their respective primary surfaces 50 facing and covering the window 34, and with their respective portions P₁, P₂, P₃ of the first, second and third stripes S₁, S₂, S₃ being disposed in contact with the window periphery 36. Additionally, and as described in more detail below, each of the two cut segments 48 may overlap an entirety of the window 34. Note that the orienting/registration of the two cut segments 48 mentioned above in connection with step/station “(E)” may also be performed here as part of the present step/station “(F)”. The result or outcome of the present step/station is a conductor assembly 10 according to the present disclosure. Note that in some configurations, the lamination step/station may include pressing the sandwiched elements together, and optionally heating or applying curing energy (e.g., ultraviolet light) to the sandwiched elements to promote curing, accelerating or setting the adhesive material 26.

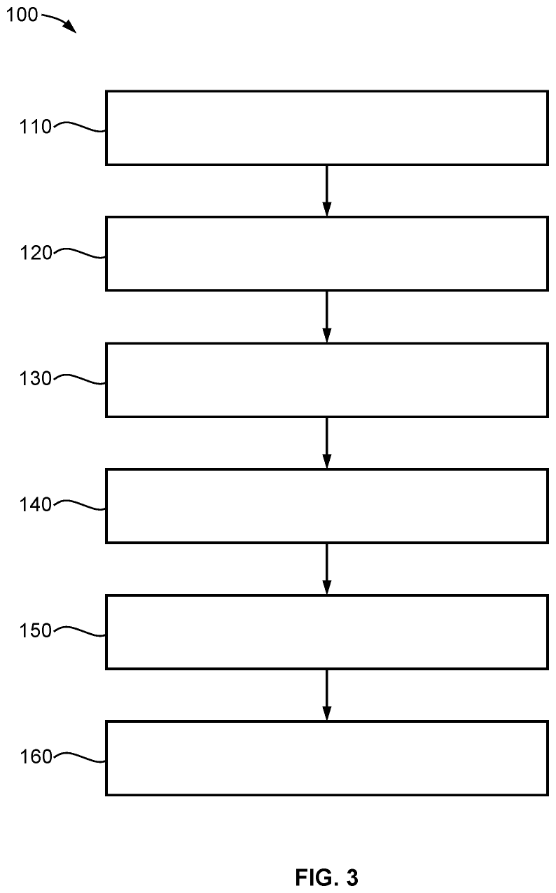

FIG. 3 shows a flowchart of the steps involved in the first method embodiment 100, which may correspond with the steps/stations shown in FIG. 2.

At block 110 (corresponding to step/station “(A)”), a roll 14 of GDL material 12 is unrolled to provide a rolled out segment 16 of the GDL material 12 having opposed first and second longitudinal edges 38, 40.

At block 120 (corresponding to step/station “(B)”), first, second and third stripes S₁, S₂, S₃ of an adhesive material 26 are applied onto a first surface 44 of the rolled out segment 16 along a length L thereof, wherein the first stripe S₁ runs along and is proximate to the first longitudinal edge 38, the second stripe S₂ runs along and is proximate to the second longitudinal edge 40, and the third stripe S₃ runs between the first and second stripes S₁, S₂, thereby defining an applied segment 46.

At block 130 (corresponding to step/station “(C)”), the applied segment 46 is cut so as to form one or more cut segments 48 each having a respective primary surface 50 on which respective portions P₁, P₂, P₃ of the first, second and third stripes S₁, S₂, S₃ are carried. Here, the applied segment 46 may be cut in a direction perpendicular to the first and second longitudinal edges 38, 40.

At block 140 (corresponding to step/station “(D)”), each cut segment 48 is trimmed to provide one or more overall outer dimensions 20 and/or one or more feature dimensions 22 for each cut segment 48.

At block 150 (corresponding to step/station “(E)”), two cut segments 48 may be oriented such that the portions P₁, P₂, P₃ of the first, second and third stripes S₁, S₂, S₃ of one of the cut segments 48 are registered with the portions P₁, P₂, P₃ of the first, second and third stripes S₁, S₂, S₃ of the other of the cut segments 48.

And at block 160 (corresponding to step/station “(F)”), a generally planar subgasket 32 is laminated between the two cut segments 48, wherein the subgasket 32 has a window 34 therethrough bounded by a window periphery 36 surrounding the window 34, and wherein the two cut segments 48 are oriented with their respective primary surfaces 50 facing and covering the window 34 and with their respective portions P₁, P₂, P₃ of the first, second and third stripes S₁, S₂, S₃ being disposed in contact with the window periphery 36. (Note that the orienting/registration of the two cut segments in block 150 may also be performed as part of the laminating step of block 160.)

In this first method embodiment 100, the unrolling and applying steps 110, 120 may be continuous and simultaneous with each other. At block 120, the first, second and third stripes S₁, S₂, S₃ of adhesive material 26 may be applied simultaneously, and may be applied to the first surface 44 using a slot die 52.

It should be noted that while the first method embodiment 100 has been illustrated and described as having three stripes S₁, S₂, S₃, this embodiment 100 may also include additional stripes as well.

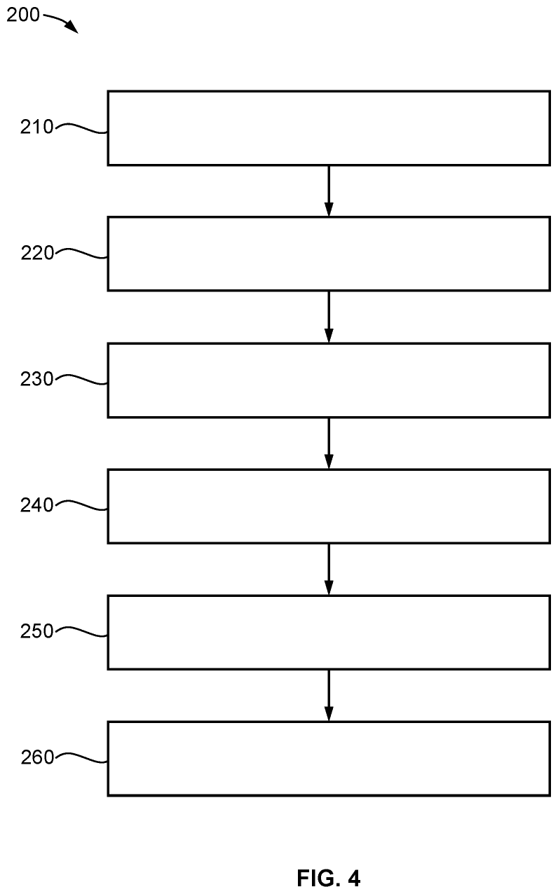

FIG. 4 shows a flowchart of the steps involved in the second method embodiment 200, which may correspond with the steps/stations shown in FIG. 2. Note that while some of the steps/stations of this second method embodiment 200 may correspond with and be similar to or the same as certain steps/stations of the first method embodiment 100, other steps/stations of this second method embodiment 200 may correspond with but be substantially different from certain other steps/stations of the first method embodiment 100.

At block 210 (corresponding to step/station “(A)”), a roll 14 of GDL material 12 is unrolled to provide a rolled out segment 16 of the GDL material 12 having opposed first and second longitudinal edges 38, 40 and a longitudinal centerline 42 between the first and second longitudinal edges 38, 40.

At block 220 (corresponding to step/station “(B)”), multiple stripes of an adhesive material 26 are applied onto a first surface 44 of the rolled out segment 16 along a length L thereof, wherein the stripes include a first lateral stripe S_{1L} running along and proximate to the first longitudinal edge 38, a second lateral stripe S_{2L} running along and proximate to the second longitudinal edge 40, a medial stripe S_{M} running proximate the longitudinal centerline 42, a first mesomedial stripe S_{1MM} running between the first lateral stripe S_{1L} and the medial stripe S_{M}, and a second mesomedial stripe S_{2MM} running between the second lateral stripe S_{2L} and the medial stripe S_{M}, thereby defining an applied segment 46. In this arrangement, a total of five stripes S_{1L}, S_{2L}, S_{M}, S_{1MM}, S_{2MM} are presented; however, this embodiment 200 may also include additional stripes as well.

At block 230 (corresponding to step/station “(C)”), the applied segment 46 is cut along the longitudinal centerline 42, as well as in a direction perpendicular to the longitudinal centerline 42, so as to form one or more cut segments 48 each having a respective primary surface 50 on which respective portions S_{1L}, S_{2L}, S_{M}, S_{1MM}, S_{2MM} of the stripes S_{1L}, S_{2L}, S_{M}, S_{1MM}, S_{2MM} are carried.

At block 240 (corresponding to step/station “(D)”), each of the one or more cut segments 48 are trimmed to provide one or more overall outer dimensions 20 and/or one or more feature dimensions 22 for each of the one or more cut segments 48.

At block 250 (corresponding to step/station “(E)”), two cut segments 48 may be oriented such that the portions P_{1L}, P_{2L}, P_{M}, P_{1MM}, P_{2MM} of the stripes S_{1L}, S_{2L}, S_{M}, S_{1MM}, S_{2MM} carried on one of the cut segments 48 are registered with the portions P_{1L}, P_{2L}, P_{M}, P_{1MM}, S_{2MM} of the stripes S_{1L}, S_{2L}, S_{M}, S_{1MM}, S_{2MM} carried on the other of the cut segments 48.

And at block 260 (corresponding to step/station “(F)”), a generally planar subgasket 32 is laminated between two cut segments 48, wherein the subgasket 32 has a window 34 therethrough bounded by a window periphery 36 surrounding the window 34, and wherein the two cut segments 48 are oriented with their respective primary surfaces 50 facing and covering the window 34 and with their respective portions P_{1L}, P_{2L}, P_{M}, P_{1MM}, P_{2MM} of the stripes S_{1L}, S_{2L}, S_{M}, S_{1MM}, S_{2MM} being disposed in contact with the window periphery 36. (Note that the orienting/registration of the two cut segments 48 in block 250 may also be performed as part of the laminating step of block 260.)

In this second method embodiment 200, the unrolling and applying steps 210, 220 may be continuous and simultaneous with each other. Additionally, the adhesive material 26 may be applied to the first surface 44 using a slot die 52, and the stripes S_{1L}, S_{2L}, S_{M}, S_{1MM}, S_{2MM} of adhesive material 26 may be applied simultaneously.

The portions of the stripes carried on a first of the two cut segments 48 may include portions P_{1L}, P_{M}, P_{1MM} of the first lateral stripe S_{1L}, the medial stripe S_{M} and the first mesomedial stripe S_{1MM}, and the portions of the stripes carried on a second of the two cut segments 48 may include portions P_{2L}, P_{M}, P_{2MM} of the second lateral stripe S_{2L}, the medial stripe S_{M} and the second mesomedial stripe S_{2MM}.

The medial stripe S_{M} may include first and second paramedial stripes S_{1PM}, S_{2PM}separated from each other by a strip 54 of the rolled out segment 16 having no adhesive material 26 applied thereon. In other words, in this arrangement, the medial stripe S_{M} may be divided into two paramedial stripes S_{1PM}, S_{2PM}. For example, the strip 54 may lie along and on top of the longitudinal centerline 42, with the two paramedial stripes S_{1PM}, S_{2PM} on either side of the strip 54. In this arrangement, the portions of the stripes carried on a first of the two cut segments 48 may include a portion P_{1L} of the first lateral stripe S_{1L}, a portion P_{1PM} of the first paramedial stripe S_{1PM}, a portion P_{1MM} of the first mesomedial stripe S_{MM}; similarly, the portions of the stripes carried on a second of the two cut segments 48 may include a portion P_{2L} of the second lateral stripe S_{2L}, a portion P_{2PM}, of the second paramedial stripe S_{2PM}, and a portion P_{2MM} of the second mesomedial stripe S_{2MM}.

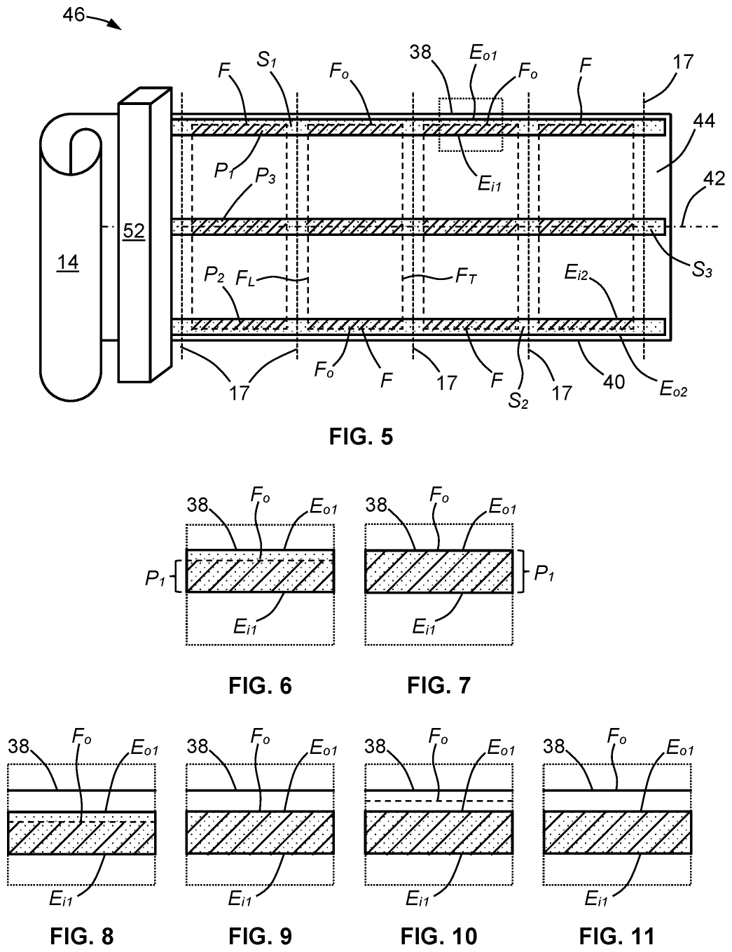

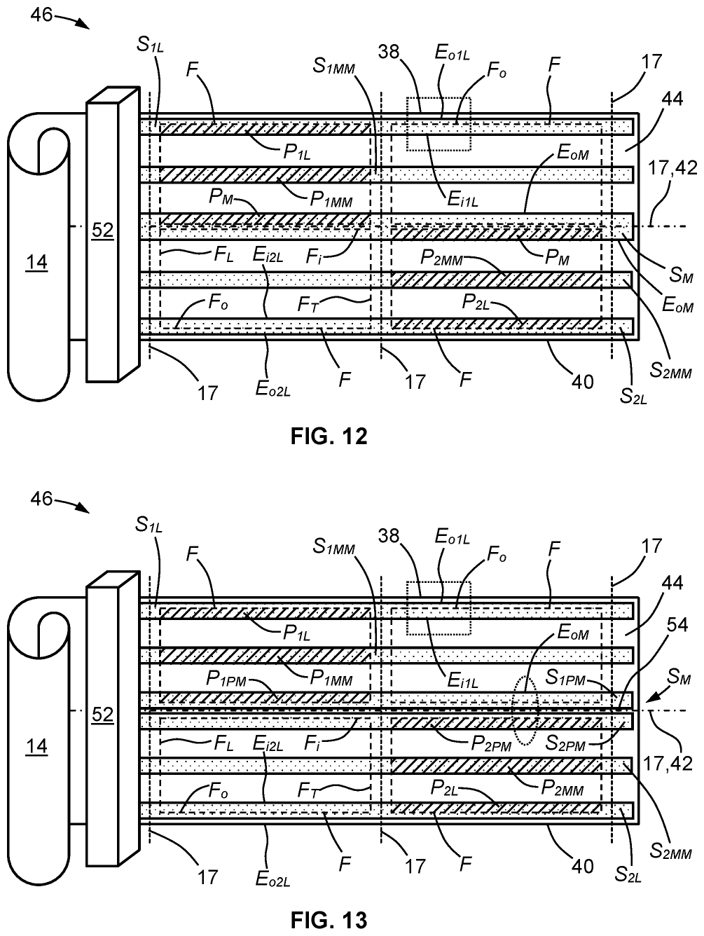

It may be noted that, as used herein, any “portion” of a particular stripe that is included within a cut segment 48 may include some or all of the area of that particular stripe. Similarly, any “portion” or “portions” of two or more stripes that is/are included within a cut segment 48 may include some or all of the area(s) of those stripes. Note that in selected drawings—such as FIGS. 5-11—the portions P₁, P₂, P₃, P_{1L}, P_{2L}, P_{M}, P_{1MM}, P_{2MM}, P_{1PM}, P_{2PM} of the stripes S₁, S₂, S₃, S_{1L}, S_{2L}, S_{M}, S_{1MM}, S_{2MM}, S_{1PM}, S_{2PM} that are to be included within a cut segment 48 may be indicated by cross-hatched areas. However, in other drawings—such as FIGS. 12-13—not all of these portions are cross-hatched, in order to make it easier to see other details in the drawings. (Specifically, in FIGS. 12-13, only two of the four cut segment footprint areas have their respective portions cross-hatched.)

For example, FIG. 5 shows a schematic perspective view of an applied segment 46 having first, second and third stripes S₁, S₂, S₃ thereon as produced by the first method embodiment 100 and by the third apparatus embodiment 180. Four cut segment footprints F are shown as dashed rectangles on the applied segment 46; these footprints F indicate where the applied segment 46 is to be cut and optionally trimmed in order to produce four cut segments 48 (e.g., by cutting along one or more of the score lines 17 by using the cutting step/station 130, and optionally trimming the resulting scored segments by utilizing the trimming step/station 140). Note that each footprint F includes two opposed outer footprint edges Fₒ, a leading footprint edge F_{L} and a trailing footprint edge F_{T}. With respect to any given footprint F in this configuration, the outer footprint edges Fₒ will be proximate the first and second longitudinal edges 38, 40, and the leading footprint edge F_{L} will be closer to the remaining roll 14 of GDL material 12 than is the trailing footprint edge F_{T}.

Note that FIG. 5 also includes a dotted rectangle along the first longitudinal edge 38. The dotted rectangle includes segments of the first longitudinal edge 38, an outer stripe edge Eₒ₁ of the first stripe S₁, an inner stripe edge Eᵢ₁ of the first stripe S₁, and the outer footprint edge Fₒ.

FIGS. 6-11 illustrate the various ways in which the edges 38, Eₒ₁, Eᵢ₁, Fₒ within the dotted rectangle of FIG. 5 may be arranged with respect to each other, with the cross-hatched areas representing the portion P₁ of the first stripe S₁ that is within the cut segment footprint F. In each of these variations, the first stripe S₁ may be applied to the first surface 44 such that its outer stripe edge Eₒ₁ is either flush with the first longitudinal edge 38 (FIGS. 6-7) or is spaced apart from the first longitudinal edge 38 (FIGS. 8-11), and the outer footprint edge Fₒ of the cut segment footprint F may be situated between the outer and inner stripe edges Eₒ₁, Eᵢ₁ (FIGS. 6 and 8), on the outer stripe edge Eₒ₁ (FIGS. 7 and 9), between the outer stripe edge Eₒ₁ and the first longitudinal edge 38 (FIG. 10), or on the first longitudinal edge 38 and spaced apart from the outer stripe edge Eₒ₁ (FIG. 11). Similar variations and arrangements may be implemented with respect to the second longitudinal edge 40, an outer stripe edge Eₒ₂ of the second stripe S₂, an inner stripe edge Eᵢ₂ of the second stripe S₂, and the outer footprint edge Fₒ of the cut segment footprint F, with the portion P₂ of the second stripe S₂ also being shown as a cross-hatched area. With respect to the third stripe S₃, the portion P₃ thereof, which is within the cut segment footprint F, includes the entirety of the third stripe S₃ that is bounded by the leading and training footprint edges F_{L}, F_{T} within the cut segment footprint F, which is also shown as a cross-hatched area.

Similar to FIG. 5, the drawing of FIG. 12 shows a schematic perspective view of an applied segment 46 having a first lateral stripe S_{1L}, a second lateral stripe S_{2L}, a medial stripe S_{M}, a first mesomedial stripe S_{1MM} and a second mesomedial stripe S₂ mm thereon as produced by the second method embodiment 200 and by the fourth apparatus embodiment 280. Again, four cut segment footprints F are shown as dashed rectangles on the applied segment 46; these footprints F indicate where the applied segment 46 is to be cut and optionally trimmed in order to produce four cut segments 48 (e.g., by cutting along one or more of the score lines 17 by using the cutting step/station 230, and optionally trimming the resulting scored segments by utilizing the trimming step/station 240). However, note that the orientation of the cut segments 48 in FIG. 12 is different from the orientation of the cut segments 48 in FIG. 5—i.e., in FIG. 5, the rectangular cut segments 48 are oriented with their long edges F_{L}, F_{T} running perpendicular to the longitudinal centerline 42, whereas in FIG. 12 the rectangular cut segments 48 are oriented with their long edges Fᵢ, Fₒ running parallel to the longitudinal centerline 42. Also note that each footprint F includes an outer footprint edge Fₒ, an inner footprint edge Fᵢ, a leading footprint edge F_{L} and a trailing footprint edge F_{T}. With respect to any given footprint F in this configuration, the outer footprint edge Fₒ will be further away from the longitudinal centerline 42 than is the inner footprint edge Fᵢ, and the leading footprint edge F_{L} will be closer to the remaining roll 14 of GDL material 12 than is the trailing footprint edge F_{T}.

Likewise, FIG. 13 shows a schematic perspective view of an applied segment 46 having a first lateral stripe S_{1L}, a second lateral stripe S_{2L}, a first paramedial stripe S_{1PM}, a second paramedial stripe S_{2PM}, a first mesomedial stripe S_{1MM} and a second mesomedial strips S_{2MM} thereon as produced by the second method embodiment 200 and by the fourth apparatus embodiment 280. Again, four cut segment footprints F are shown as dashed rectangles on the applied segment 46, indicating where the applied segment 46 is to be cut and optionally trimmed in order to produce four cut segments 48. Note that each footprint F includes an outer footprint edge Fₒ, an inner footprint edge Fᵢ, a leading footprint edge F_{L} and a trailing footprint edge F_{T}. With respect to any given footprint F in this configuration, the outer footprint edge Fₒ will be further away from the longitudinal centerline 42 than is the inner footprint edge Fᵢ, and the leading footprint edge F_{L} will be closer to the remaining roll 14 of GDL material 12 than is the trailing footprint edge F_{T}.

Note that each of FIGS. 12-13 also includes a dotted rectangle along the first longitudinal edge 38, similar to FIG. 5. Here, the dotted rectangles include segments of the first longitudinal edge 38, an outer stripe edge E_{o1L} of the first lateral stripe S_{IL}, an inner stripe edge E_{i1L} of the first lateral stripe S_{IL}, and an outer footprint edge Fₒ, with each dotted rectangle bounding some of the portion P_{IL} of the first lateral stripe S_{IL}. As with the edges within the dotted rectangle of FIGS. 5-11, various arrangements may be implemented with respect to the edges (38, E_{o1L}, E_{i1L}, Fₒ) which bound and define the portions P_{1L} of the first lateral stripe S_{1L}, in a manner similar to the details shown in FIGS. 6-11.

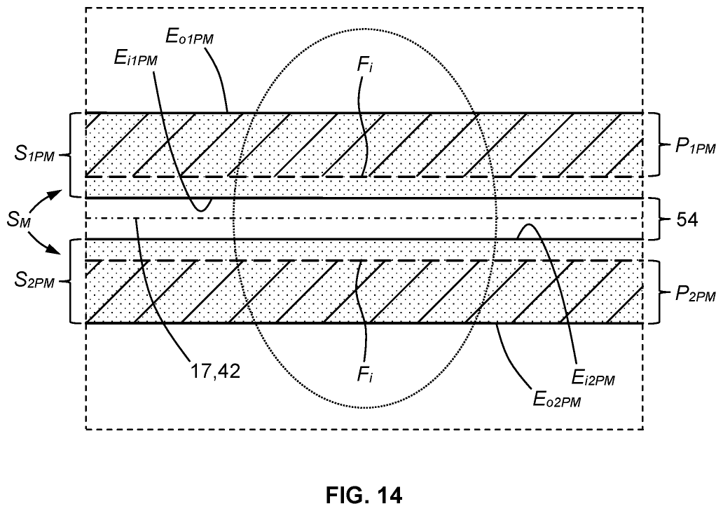

Although not shown explicitly in the drawings, variations and arrangements similar to those shown in FIGS. 6-11 may also be implemented with respect to: (i) the portions P_{2L} of the second lateral stripe S_{2L} (and the spatial arrangements among the second longitudinal edge 40, an outer stripe edge E_{o2L} of the second lateral stripe S_{2L}, an inner stripe edge E_{i2L} of the second lateral stripe S_{2L}, and the outer footprint edge Fₒ of the cut segment footprint F); (ii) the portions P_{M} on either side of the medial stripe S_{M} (and the spatial arrangements among the longitudinal centerline 42, an outer stripe edge E_{oM} of the medial stripe S_{M}, and the inner footprint edge Fᵢ of the cut segment footprint F); and (iii) as exemplified within the dotted oval of FIG. 13 and the close-up view of the dotted oval area in FIG. 14, the respective portions P_{1PM}, P_{2PM} of the first and second paramedial stripes S_{1PM}, S_{2PM}, S_{2PM} (and the spatial arrangements among the longitudinal centerline 42, the inner stripe edges E_{i1PM}, E_{i2PM} and outer stripe edges E_{o1PM}, E_{o2PM} of the first and second paramedial stripes S_{1PM}, S_{2PM}, and the inner footprint edge Fᵢ of the cut segment footprint F).

With respect to the first and second mesomedial stripes S_{1MM}, S_{2MM}, the respective portions P_{1MM}, P_{2MM} thereof, which are within the cut segment footprint F, includes the entireties of the first and second mesomedial stripes S_{1MM}, S_{2MM} that are bounded by the leading and training footprint edges F_{L}, F_{T} within the cut segment footprint F. This can be seen in FIGS. 12-13, where two of these portions P_{1MM}, P_{2MM} are shown as cross-hatched areas in each drawing.

FIG. 15 shows an exploded schematic side view of a subgasket 32 and two cut segments 48 prior to lamination, and FIG. 16 shows an assembled schematic side view of the subgasket 32 and two cut segments 48 of FIG. 15 after lamination, thus forming a completed conductor assembly 10. As described above, a first cut segment 48₁ may be positioned with its first surface 44 and primary surface 50₁ (and the segment's portions P₁, P₂, P₃ of the first, second and third stripes S₁, S₂, S₃) facing downward, and a second cut segment 48₂ may be positioned with its first surface 44 and primary surface 50₂ (and this segment's portions P₁, P₂, P₃ of the first, second and third stripes S₁, S₂, S₃) facing upward, with the first cut segment 48₁ hovering above the second cut segment 48₂ such that the respective portions P₁, P₂, P₃ of the first, second and third stripes S₁, S₂, S₃ of the two cut segments 48₁, 48₂ are registered (i.e., vertically aligned) with each other. Note that while FIG. 15 shows the two first portions P₁ vertically aligned with each other and the two second portions P₂ vertically aligned with each other, it is also possible to vertically align a first portion P₁ with a second P₂ (e.g., by rotating one of the two cut segments 48 180 degrees from the orientation shown).

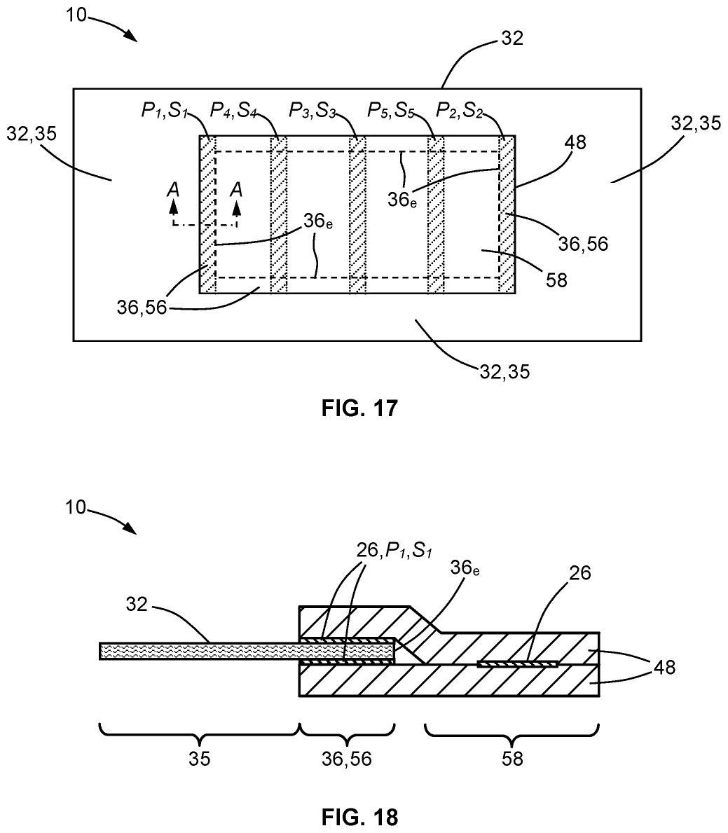

FIG. 17 shows a schematic plan view of a completed conductor assembly 10 according to one embodiment, and FIG. 18 shows a close-up schematic section view of the conductor assembly 10 as viewed along line A-A of FIG. 17. In the embodiment shown here, the conductor assembly 10 has been fabricated using the first method embodiment 100 and/or the third apparatus embodiment 180, similar to FIGS. 5, 15 and 16. However, note that whereas the applied and cut segments 46, 48 shown in FIGS. 5, 15 and 16 show three stripes S₁, S₂, Sₛ and their respective portions P₁, P₂, P₃, the embodiment shown in FIG. 17 shows five stripes S₁, S₂, S₃, S₄, S₅ and their respective portions P₁, P₂, P₃, P₄, P₅.

Five points may be deduced from comparing the embodiment shown in FIG. 17 versus the embodiments shown in FIGS. 5, 12, 13, 15 and 16. First, it may be noted that the first method 100 and/or third apparatus 180 used to produce the applied segment 46 of FIG. 5 having three stripes S₁, S₂, S₃ may also be used to produce the cut segment 48 of FIG. 17 having five stripes S₁, S₂, S₃, S₄, S₅, simply by adding a fourth stripe S₄ and a fifth stripe S₅ as part of step/station “(B)”. For example, the slot die 52 may be modified to apply a fourth stripe S₄ between the first and third stripes S₁, S₂, and a fifth stripe S₅ between the second and third stripes S₂, S₃. Second, it may be noted that a five-stripe cut segment 48 similar to that shown in FIG. 17 may alternatively be produced using the second method 200 and/or the fourth apparatus 280; in such a case, the structure of the cut segment 48 produced would be the same, but the naming convention of the stripes would differ. (I.e., in this case, the stripes may be referred to as a first lateral stripe S_{1L}, a second lateral stripe S_{2L}, a medial stripe S_{M}, a first mesomedial stripe S_{1MM} and a second mesomedial stripe S_{2MM}, rather than being referred to as first through fifth stripes S₁-S₅.) Third, it may be noted that while the five stripes S₁-S₅ shown in FIG. 17 are depicted as running vertically in this view, in other embodiments the stripes may run horizontally (i.e., rotated 90 degrees from the orientation shown in FIG. 17). Fourth, it may be noted that any number of stripes may be applied, as long as at least three stripes are used. And fifth, it may be noted that the respective widths of the stripes may all be the same, or they may differ. For example, in one embodiment utilizing three stripes S₁, S₂, S₃, the first and second stripes S₁, S₂ may have the same width as each other while the third stripe S₃ may be wider than the first and second stripes S₁, S₂.

Returning now to the close-up view of FIG. 18, it may be seen that the subgasket 32 may include a first subgasket layer 32₁ and a second subgasket layer 32₂ which are adhered together by an adhesive 33. These subgasket layers 32₁, 32₂ may be polymeric and/or elastomeric films, and the adhesive 33 may optionally be the same as the adhesive material 26. As illustrated in FIG. 18, the first subgasket layer 32₁ may be longer than the second subgasket layer 32₂, thereby providing a main subgasket area 35 where the two subgasket layers 32₁, 32₂ overlap each other. Here, a portion of the first subgasket layer 32₁ extends beyond the outer periphery of the second subgasket layer 32₂ and serves as the window periphery 36 which defines and frames the subgasket window 34. (Note that the subgasket window 34 is not explicitly shown in FIG. 18, but the subgasket window 34 is explicitly shown in FIGS. 15-16.) The window periphery 36 is sandwiched or laminated between the two cut segments 48, thereby providing an overlap area 56 as shown. The portion of the subgasket window 32 that is not the window periphery 36 is shown as a main subgasket area 55, both in FIG. 18 and in FIG. 17.

As shown in FIG. 18, the inwardly extending edge of the subgasket 32 may define a window periphery edge 36ₑ, which defines the inward extent of the overlap area 56. As indicated by FIG. 17, the window periphery 36, the window periphery edge 36ₑ and the overlap area 56 may extend around a generally rectangular area towards the center of the subgasket 32 and the conductor assembly 10. Further inward of the overlap area 56, the two cut segments 48 may be optionally brought together and adhered to each other, such as by one or more vertically registered stripes or portions of the adhesive material 26, and optionally by one or more additional deposits of the adhesive material 26. Alternatively, the respective surfaces of the two cut segments 48 may be spaced apart from each other, with only the registered stripes or portions of adhesive material 26 adhering to each other, as illustrated in FIG. 16. A main GDL area 58 may be defined inward of the overlap area 56.

Returning to the exploded and assembled views of FIGS. 15-16, according to one embodiment, a conductor assembly 10 and its components are shown. In this embodiment, the conductor assembly 10 includes first and second cut segments 48 of GDL material 12, wherein each of the first and second cut segments 48 has a respective first surface 44, respective opposed first and second longitudinal edges 38, 40, and respective first, second and third stripes S₁, S₂, S₃ of an adhesive material 26 applied onto the respective first surface 44 along a respective length of the respective first surface 44, wherein for each of the first and second cut segments 48 the respective first stripe S₁ runs along and is proximate to the respective first longitudinal edge 38, the respective second stripe S₂ runs along and is proximate to the respective second longitudinal edge 40, and the respective third stripe S₃ runs between the respective first and second stripes S₁, S₂. The conductor assembly 10 also includes a generally planar subgasket 32 having a window 34 therethrough bounded by a window periphery 36 surrounding the window 34. The generally planar subgasket 32 is sandwiched between the first and second cut segments 48 with the segments 48 oriented with their respective first surfaces 44 facing and covering the window 34 and with their respective first and second stripes S₁, S₂ being disposed in contact with the window periphery 36.

The first and second cut segments 48 may be oriented such that the first, second and third stripes S₁, S₂, S₃ of one of the first and second cut segments 48 are registered with the first, second and third stripes S₁, S₂, S₃ of the other of the first and second cut segments 48. For each of the first and second cut segments 48, the respective first, second and third stripes S₁, S₂, S₃ may be parallel with each other.

The respective third stripes S₃ of the first and second cut segments 48 may be adhered to each other, and the respective first and second stripes S₁, S₂ of the first and second cut segments 48 may be disposed in contact with less than an entirety (e.g., only a portion) of the window periphery 36.

The adhesive material 26 may be an ionomer solution. For example, the ionomer solution may be a perfluorosulfonic acid polymer. Optionally, the ionomer solution may contain an electrically conductive additive therein, such as carbon powder or carbon nanoparticles.

Again referring to FIGS. 15-16, according to another embodiment, a conductor assembly 10 and its components are shown. In this embodiment, the conductor assembly 10 includes first and second cut segments 48 of GDL material 12, wherein each of the first and second cut segments 48 has a respective first surface 44, respective opposed first and second longitudinal edges 38, 40, and respective first and second stripes S₁, S₂ of an ionomer solution applied onto the respective first surface 44 along a respective length of the respective first surface 44, wherein for each of the first and second cut segments 48 the respective first stripe S₁ runs along and is proximate to the respective first longitudinal edge 38 and the respective second stripe S₂ runs along and is proximate to the respective second longitudinal edge 40. The conductor assembly 10 also includes a generally planar subgasket 32 having a window 34 therethrough bounded by a window periphery 36 surrounding the window 34. The generally planar subgasket 32 is sandwiched between the first and second cut segments 48 with the segments 48 oriented with their respective first surfaces 44 facing and covering the window 34 and with their respective first and second stripes S₁, S₂ being disposed in contact with the window periphery 36.

Each of the first and second cut segments 48 may include a respective third stripe S₃ of the ionomer solution applied onto the respective first surface 44 along the respective length of the respective first surface 44 and running between the respective first and second stripes S₁, S₂. The respective third stripes S₃ of the first and second cut segments 48 may be self-adhered to each other (i.e., without the need for any additional or other adhesive material 26).

In this embodiment, the first and second cut segments 48 may be oriented such that the first and second stripes S₁, S₂ of one of the first and second cut segments 48 are registered with the first and second stripes S₁, S₂ of the other of the first and second cut segments 48. For each of the first and second cut segments 48, the respective first and second stripes S₁, S₂ may be parallel with each other.

The ionomer solution may be a perfluorosulfonic acid polymer, and the ionomer solution may contain an electrically conductive additive therein.

Further in this embodiment, the respective first and second stripes S₁, S₂ of the first and second cut segments 48 may be disposed in contact with less than an entirety of the window periphery 36. Additionally, each of the first and second cut segments 48 may include one or more respective deposits of the ionomer solution on the respective first surface 44 between the respective first and second stripes S₁, S₂, wherein the one or more deposits on one of the first and second cut segments 48 are registered with and self-adhered to the one or more deposits on the other of the first and second cut segments 48. Optionally, in this embodiment, the one or more deposits may include or take the form of the third stripe S₃, and the third stripe S₃ or the one or more deposits of ionomer solution may span some or all of the distance/area between the first and second stripes S₁, S₂.

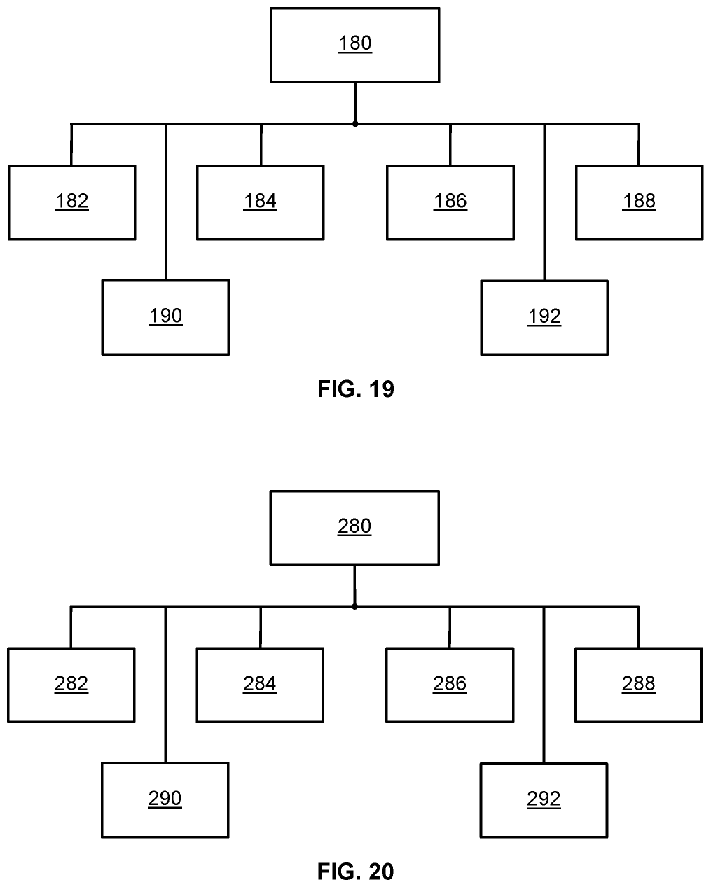

FIG. 19 shows a block diagram of the third apparatus embodiment 180, in which the apparatus 180 includes an unrolling module 182, an application module 184, a cutting module 186, a trimming module 188, an orienting/registering module 190 and a laminating module 192.

The unrolling module 182 is configured for unrolling a roll 14 of GDL material 12 to provide the rolled out segment 16.

The application module 184 is configured for applying first, second and third stripes S₁, S₂, S₃ of an adhesive material 26 onto a first surface 44 of the rolled out segment 16 of GDL material 12 along a length L thereof, with the rolled out segment 16 having opposed first and second longitudinal edges 38, 40, wherein the first stripe S₁ runs along and is proximate to the first longitudinal edge 38, the second stripe S₂ runs along and is proximate to the second longitudinal edge 40, and the third stripe S₃ runs between the first and second stripes S₁, S₂, thereby defining an applied segment 46.

The cutting module 186 is configured for cutting the applied segment 46 so as to form one or more cut segments 48 each having a respective primary surface 50 on which respective portions P₁, P₂, P₃ of the first, second and third stripes S₁, S₂, S₃ are carried.

The trimming module 188 is configured for trimming each of the one or more cut segments 48 to provide one or more overall outer dimensions 20 and/or one or more feature dimensions 22 for each of the one or more cut segments 48.

The orienting/registering module 190 is configured to orient two of the cut segments 48 such that the portions P₁, P₂, P₃ of the first, second and third stripes S₁, S₂, S₃ of one of the cut segments 48 are registered with the portions P₁, P₂, P₃ of the first, second and third stripes S₁, S₂, S₃ of the other of the cut segments 48.

Finally, the laminating module 192 is configured for laminating a generally planar subgasket 32 between the two cut segments 48, wherein the subgasket 32 has a window 34 therethrough bounded by a window periphery 36 surrounding the window 34, and wherein the two cut segments 48 are oriented with their respective primary surfaces 50 facing and covering the window 34 and with their respective portions P₁, P₂, P₃ of the first, second and third stripes S₁, S₂, S₃ being disposed in contact with the window periphery 36.

In the foregoing arrangement, the unrolling module 182 and the application module 184 may be configured to cooperate with each other such that the unrolling and the applying are continuous and simultaneous with each other. Additionally, the orienting/registration of the two cut segments 48 that is described above in connection with the orienting/registration module 190 may optionally be performed by the laminating module 192.

FIG. 20 shows a block diagram of the fourth apparatus embodiment 280, in which the apparatus 280 includes an unrolling module 282, an application module 284, a cutting module 286, a trimming module 288, an orienting/registering module 290 and a laminating module 292. Note that while some of the modules of this fourth apparatus embodiment 280 may correspond with and be similar to or the same as certain modules of the third apparatus embodiment 180, other modules of this fourth apparatus embodiment 280 may correspond with but be substantially different from certain other modules of the third apparatus embodiment 180.

The unrolling module 282 is configured for unrolling a roll 14 of GDL material 12 to provide the rolled out segment 16.

The application module 284 is configured for applying stripes of an adhesive material 26 onto a first surface 44 of the rolled out segment 16 of GDL material 12 along a length L thereof. Here, the rolled out segment 16 has opposed first and second longitudinal edges 38, 40 and a longitudinal centerline 42 between the first and second longitudinal edges 38, 40, wherein the stripes include a first lateral stripe S_{1L} running along and proximate to the first longitudinal edge 38, a second lateral stripe S_{2L} running along and proximate to the second longitudinal edge 40, a medial stripe S_{M} running proximate the longitudinal centerline 42, a first mesomedial stripe S_{1MM} running between the first lateral and medial stripes S_{1L}, S_{M}, and a second mesomedial stripe S_{2MM} running between the second lateral and medial stripes S_{2L}, S_{M}, thereby defining an applied segment 46.

The cutting module 286 is configured for cutting the applied segment 46 along the longitudinal centerline 42 and in a direction perpendicular to the longitudinal centerline 42 so as to form one or more cut segments 48 each having a respective primary surface 50 on which respective portions of the stripes are carried.

The trimming module 288 is configured for trimming each of the one or more cut segments 48 to provide one or more overall outer dimensions 20 and/or one or more feature dimensions 22 for each of the one or more cut segments 48.

The orienting/registering module 290 is configured to orient two of the cut segments 48 such that the portions P_{1L}, P_{2L}, P_{M}, P_{1MM}, P_{2MM} of the stripes S_{1L}, S_{2L}, S_{M}, S_{1MM}, S_{2MM} carried on one of the cut segments 48 are registered with the portions P_{1L}, P_{2L}, P_{M}, P_{1MM}, P_{2MM} of the stripes S_{1L}, S_{2L}, S_{M}, S_{1MM}, S_{2MM} carried on the other of the cut segments 48. In configurations where the medial stripe S_{M} has been bifurcated into first and second paramedial stripes S_{1PM}, S_{2PM}, the portions P_{1PM}, P_{2PM} of the paramedial stripes S_{1PM}, S_{2PM} carried on one of the cut segments 48 may be registered with the portions P_{1PM}, P_{2PM} of the paramedial stripes S_{1PM}, S_{2PM} carried on the other of the cut segments 48.

Finally, the laminating module 292 is configured for laminating a generally planar subgasket 32 between the two cut segments 48, wherein the subgasket 32 has a window 34 therethrough bounded by a window periphery 36 surrounding the window 34, and wherein the two cut segments 48 are oriented with their respective primary surfaces 50 facing and covering the window 34 and with their respective portions of the stripes being disposed in contact with the window periphery 36.

In the above arrangement, the unrolling module 282 and the application module 284 may be configured to cooperate with each other such that the unrolling and the applying are continuous and simultaneous with each other. Additionally, the orienting/registration of the two cut segments 48 that is described above in connection with the orienting/registration module 290 may optionally be performed by the laminating module 292.

In either of the third and fourth apparatus embodiments 180, 280, the unrolling module 182, 282 may include robotic or other automated equipment for handling and unrolling the roll 14 of GDL material 12, the application module 184, 284 may include a slot die 52 configured for movement lengthwise along the rolled out segment 16 while dispensing adhesive material 26 into suitable stripes to provide an applied segment 46, the cutting module 186, 286 may include a knife, scissors or another suitable cutting tool 15 for cutting the applied segment 46 into one or more cut segments 48, the trimming module 188, 288 may include a cutting die 25 or other suitable tool(s) for cutting and shaping the overall outer dimensions 20 and/or feature dimensions 22, the orienting/registering module 190, 290 may include robotic or other automated equipment for handling and orienting/placing cut segments 48, and the laminating module 192, 292 may include robotic or other automated equipment for handling, placing, orienting, registering, stacking/sandwiching and holding/pressing together the subgasket 32 between two cut segments 48.

The methods 100, 200 and apparatuses 180, 280 of the present disclosure provide various advantages and benefits over the abovementioned customary approach for assembling a conductor assembly 10 for a PEM fuel cell. For instance, the approach described in the present disclosure may utilize less adhesive material 26 than is used in the customary approach, thus conserving material and reducing cost. Additionally, the approach described in the present disclosure may utilize the same ionomer solution that is used for coating MEA components to provide the multiple stripes, and much of the same equipment and tools that are utilized in the customary approach may be used for the approach described in the present disclosure as well, thus limiting additional cost.

As one having skill in the relevant art will appreciate, the methods 100, 200 and apparatuses 180, 280 of the present disclosure may be presented or arranged in a variety of different configurations and embodiments.

According to one configuration of the first method embodiment, a method 100 for assembling a conductor assembly 10 for a PEM fuel cell includes: (i) at block 110, unrolling a roll 14 of GDL material 12 to provide a rolled out segment 16 of the GDL material 12 having opposed first and second longitudinal edges 38, 40; (ii) at block 120, applying first, second and third stripes S₁, S₂, S₃ of an adhesive material 26 onto a first surface 44 of the rolled out segment 16 along a length L thereof, wherein the first stripe S₁ runs along and is proximate to the first longitudinal edge 38, the second stripe S₂runs along and is proximate to the second longitudinal edge 40, and the third stripe S₃ runs between the first and second stripes S₁, S₂, thereby defining an applied segment 46; (iii) at block 130, cutting the applied segment 46 so as to form one or more cut segments 48 each having a respective primary surface 50 on which respective portions P₁, P₂, P₃ of the first, second and third stripes S₁, S₂, S₃ are carried; and (iv) at block 160, laminating a generally planar subgasket 32 between two of the cut segments 48, wherein the subgasket 32 has a window 34 therethrough bounded by a window periphery 36 surrounding the window 34, and wherein the two cut segments 48 are oriented with their respective primary surfaces 50 facing and covering the window 34 and with their respective portions P₁, P₂, P₃ of the first, second and third stripes S₁, S₂, S₃ being disposed in contact with the window periphery 36.

In this embodiment, the unrolling and applying steps (blocks 110 and 120) may be continuous and simultaneous with each other. The first, second and third stripes S₁, S₂, S₃ of adhesive material 26 may be applied simultaneously. and the adhesive material 26 may be applied to the first surface 44 using a slot die 52.

The method 100 may further include, at block 150, orienting the two segments 48 such that the portions P₁, P₂, P₃ of the first, second and third stripes S₁, S₂, S₃ of one of the cut segments 48 are registered with the portions P₁, P₂, P₃ of the first, second and third stripes S₁, S₂, S₃ of the other of the cut segments 48.

In the cutting step (block 130), the applied segment 46 may be cut in a direction perpendicular to the first and second longitudinal edges 38, 40.

The method 100 may further include, at block 140, trimming each of the one or more cut segments 48 to provide one or more overall outer dimensions 20 and/or one or more feature dimensions 22 for each of the one or more cut segments 48.

According to one configuration of the second method embodiment, a method 200 for assembling a conductor assembly 10 for a PEM fuel cell includes: (i) at block 210, unrolling a roll 14 of GDL material 12 to provide a rolled out segment 16 of the GDL material 12 having opposed first and second longitudinal edges 38, 40 and a longitudinal centerline 42 between the first and second longitudinal edges 38, 40; (ii) at block 220, applying stripes of an adhesive material 26 onto a first surface 44 of the rolled out segment 16 along a length L thereof, wherein the stripes include a first lateral stripe S_{1L} running along and proximate to the first longitudinal edge 38, a second lateral stripe S_{2L} running along and proximate to the second longitudinal edge 40, a medial stripe S_{M} running proximate the longitudinal centerline 42, a first mesomedial stripe S_{1MM} running between the first lateral and medial stripes S_{1L}, S_{M}, and a second mesomedial stripe S_{2MM} running between the second lateral and medial stripes S_{2L}, S_{M}, thereby defining an applied segment 46; at block 230, (iii) cutting the applied segment 46 along the longitudinal centerline 42 and in a direction perpendicular to the longitudinal centerline 42 so as to form one or more cut segments 48 each having a respective primary surface 50 on which respective portions P_{1L}, P_{2L}, P_{M}, P_{1MM}, P_{2MM} of the stripes S_{1L}, S_{2L}, S_{M}, SIMM, S_{2MM} are carried; and (iv) at block 260, laminating a generally planar subgasket 32 between two of the cut segments 48, wherein the subgasket 32 has a window 34 therethrough bounded by a window periphery 36 surrounding the window 34, and wherein the two cut segments 48 are oriented with their respective primary surfaces 50 facing and covering the window 34 and with their respective portions P_{1L}, P_{2L}, P_{M}, P_{MM}, P_{2MM} of the stripes S_{1L}, S_{2L}, S_{M}, S_{1MM}, S_{2MM} being disposed in contact with the window periphery 36.

In this embodiment, the unrolling and applying steps (blocks 210 and 220) may be continuous and simultaneous with each other. Additionally, the adhesive material 26 may be applied to the first surface 44 using a slot die 52, and the stripes of adhesive material 26 may be applied simultaneously. The method 200 may further include, at block 250, orienting the two cut segments 48 such that the portions P_{1L}, P_{2L}, P_{M}, P_{1MM}, P_{2MM} of the stripes S_{1L}, S_{2L}, S_{M}, S_{1MM}, S_{2MM} carried on one of the two cut segments 48 are registered with the portions P_{1L}, P_{2L}, P_{M}, P_{1MM}, P_{2MM} of the stripes S_{1L}, S_{2L}, S_{M}, S_{1MM}, S_{2MM} carried on the other of the two cut segments 48.

The portions of the stripes carried on a first of the two cut segments 48 may include portions P_{1L}, P_{M}, P_{1MM} of the first lateral stripe S_{1L}, the medial stripe S_{M} and the first mesomedial stripe S_{MM}, and the portions of the stripes carried on a second of the two cut segments 48 may include portions P_{2L}, P_{M}, P_{2MM} of the second lateral stripe S_{2L}, the medial stripe S_{M} and the second mesomedial stripe S_{2MM}.

The medial stripe S_{M} may include first and second paramedial stripes S_{1PM}, S_{2PM} separated from each other by a strip 54 of the rolled out segment 16 having no adhesive material 26 applied thereon. In this arrangement, the portions of the stripes carried on a first of the two cut segments 48 may include portions P_{1L}, P_{1PM}, P_{1MM} of the first lateral stripe S_{1L}, the first paramedial stripe S_{1PM} and the first mesomedial stripe S_{MM}, and the portions of the stripes carried on a second of the two cut segments 48 may include portions P_{2L}, P_{2PM}, P_{2MM} of the second lateral stripe S_{2L}, the second paramedial stripe S_{2PM} and the second mesomedial stripe S_{2MM}.

According to one configuration of the third apparatus embodiment, an apparatus 180 for assembling a conductor assembly 10 for a PEM fuel cell includes an application module 184, a cutting module 186 and a laminating module 192. The application module 184 is configured for applying first, second and third stripes S₁, S₂, S₃ of an adhesive material 26 onto a first surface 44 of a rolled out segment 16 of GDL material 12 along a length L thereof, the rolled out segment 16 having opposed first and second longitudinal edges 38, 40, wherein the first stripe S₁ runs along and is proximate to the first longitudinal edge 38, the second stripe S₂ runs along and is proximate to the second longitudinal edge 40, and the third stripe S₃ runs between the first and second stripes S₁, S₂, thereby defining an applied segment 46. The cutting module 186 is configured for cutting the applied segment 46 so as to form one or more cut segments 48 each having a respective primary surface 40 on which respective portions P₁, P₂, P₃ of the first, second and third stripes S₁, S₂, S₃ are carried. The laminating module 192 is configured for laminating a generally planar subgasket 32 between two of the cut segments 48, wherein the subgasket 32 has a window 34 therethrough bounded by a window periphery 36 surrounding the window 34, and wherein the two cut segments 48 are oriented with their respective primary surfaces 50 facing and covering the window 34 and with their respective portions P₁, P₂, P₃ of the first, second and third stripes S₁, S₂, S₃ being disposed in contact with the window periphery 36.

The apparatus 180 may also include an unrolling module 182 configured for unrolling a roll 14 of the GDL material 12 to provide the rolled out segment 16. In this arrangement, the unrolling module 182 and the application module 184 may be configured to cooperate with each other such that the unrolling and the applying are continuous and simultaneous with each other.

The apparatus 180 may further include a trimming module 188 configured for trimming each of the one or more cut segments 48 to provide one or more overall outer dimensions 20 and/or one or more feature dimensions 22 for each of the one or more cut segments 48.

According to one configuration of the fourth apparatus embodiment, an apparatus 282 for assembling a conductor assembly 10 for a PEM fuel cell includes an application module 284, a cutting module 286 and a laminating module 292. The application module 284 is configured for applying stripes of an adhesive material 26 onto a first surface 44 of a rolled out segment 16 of GDL material 12 along a length L thereof, the rolled out segment 16 having opposed first and second longitudinal edges 38, 40 and a longitudinal centerline 42 between the first and second longitudinal edges 38, 40, wherein the stripes include a first lateral stripe S_{1L} running along and proximate to the first longitudinal edge 38, a second lateral stripe S_{2L} running along and proximate to the second longitudinal edge 40, a medial stripe S_{M}running proximate the longitudinal centerline 42, a first mesomedial stripe S_{1MM} running between the first lateral and medial stripes S_{1L}, S_{M}, and a second mesomedial stripe S_{2MM} running between the second lateral and medial stripes S_{2L}, S_{M}, thereby defining an applied segment 46. The cutting module 286 is configured for cutting the applied segment 46 along the longitudinal centerline 42 and in a direction perpendicular to the longitudinal centerline 42 so as to form one or more cut segments 48 each having a respective primary surface 50 on which respective portions P_{1L}, P_{2L}, P_{M}, P_{1MM}, P_{2MM} of the stripes S_{1L}, S_{2L}, S_{M}, SIMM, S_{2MM} are carried. The laminating module 292 is configured for laminating a generally planar subgasket 32 between two of the cut segments 48, wherein the subgasket 32 has a window 34 therethrough bounded by a window periphery 36 surrounding the window 34, and wherein the two cut segments 48 are oriented with their respective primary surfaces 50 facing and covering the window 34 and with their respective portions P_{1L}, P_{2L}, P_{M}, P_{1MM}, P_{2MM} of the stripes S_{1L}, S_{2L}, S_{M}, S_{1MM}, S_{2MM} being disposed in contact with the window periphery 36.

The apparatus 280 may also include an unrolling module 282 configured for unrolling a roll 14 of the GDL material 12 to provide the rolled out segment 16. In this arrangement, the unrolling module 282 and the application module 284 may be configured to cooperate with each other such that the unrolling and the applying are continuous and simultaneous with each other.

The apparatus 280 may further include a trimming module 288 configured for trimming each of the one or more cut segments 48 to provide one or more overall outer dimensions 20 and/or one or more feature dimensions 22 for each of the one or more cut segments 48.

Note that while the stripes of adhesive material 26 are shown in the drawings as being formed as continuous straight lines, any one or more of these stripes (including all of the stripes) for any given embodiment 100, 200, 180, 280 may optionally be formed as non-continuous lines, such as dashed lines.

While various steps of the methods 100, 200 have been described as being separate blocks, and various functions of the apparatuses 180, 280 have been described as being separate modules or elements, it may be noted that two or more steps may be combined into fewer blocks, and two or more functions may be combined into fewer modules or elements. Similarly, some steps described as a single block may be separated into two or more blocks, and some functions described as a single module or element may be separated into two or more modules or elements. Additionally, the order of the steps or blocks described herein may be rearranged in one or more different orders, and the arrangement of the functions, modules and elements may be rearranged into one or more different arrangements.

(As used herein, a “module” may include hardware and/or software, including executable instructions, for receiving one or more inputs, processing the one or more inputs, and providing one or more corresponding outputs. Also note that at some points throughout the present disclosure, reference may be made to a singular input, output, element, etc., while at other points reference may be made to plural/multiple inputs, outputs, elements, etc. Thus, weight should not be given to whether the input(s), output(s), element(s), etc. are used in the singular or plural form at any particular point in the present disclosure, as the singular and plural uses of such words should be viewed as being interchangeable, unless the specific context dictates otherwise.)

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A conductor assembly for a proton exchange membrane fuel cell, comprising:
first and second cut segments of gas diffusion layer (GDL) material, wherein each of the first and second cut segments has a respective first surface, respective opposed first and second longitudinal edges, and respective first, second and third stripes of an adhesive material applied onto the respective first surface along a respective length of the respective first surface, wherein for each of the first and second cut segments the respective first stripe runs along and is proximate to the respective first longitudinal edge, the respective second stripe runs along and is proximate to the respective second longitudinal edge, and the respective third stripe runs between the respective first and second stripes; and
a generally planar subgasket having a window therethrough bounded by a window periphery surrounding the window;
wherein the generally planar subgasket is sandwiched between the first and second cut segments with the first and second cut segments oriented with their respective first surfaces facing and covering the window and with their respective first and second stripes being disposed in contact with the window periphery.

2. The conductor assembly of claim 1, wherein the first and second cut segments are oriented such that the first, second and third stripes of one of the first and second cut segments are registered with the first, second and third stripes of the other of the first and second cut segments.

3. The conductor assembly of claim 1, wherein for each of the first and second cut segments the respective first, second and third stripes are parallel with each other.

4. The conductor assembly of claim 1, wherein the respective third stripes of the first and second cut segments are adhered to each other.

5. The conductor assembly of claim 1, wherein the adhesive material is an ionomer solution.

6. The conductor assembly of claim 5, wherein the ionomer solution is a perfluorosulfonic acid polymer.

7. The conductor assembly of claim 5, wherein the ionomer solution contains an electrically conductive additive therein.

8. The conductor assembly of claim 1, wherein the respective first and second stripes of the first and second cut segments are disposed in contact with less than an entirety of the window periphery.

9. A conductor assembly for a proton exchange membrane fuel cell, comprising:
first and second cut segments of gas diffusion layer (GDL) material, wherein each of the first and second cut segments has a respective first surface, respective opposed first and second longitudinal edges, and respective first and second stripes of an ionomer solution applied onto the respective first surface along a respective length of the respective first surface, wherein for each of the first and second cut segments the respective first stripe runs along and is proximate to the respective first longitudinal edge and the respective second stripe runs along and is proximate to the respective second longitudinal edge; and
a generally planar subgasket having a window therethrough bounded by a window periphery surrounding the window;
wherein the generally planar subgasket is sandwiched between the first and second cut segments with the first and second cut segments oriented with their respective first surfaces facing and covering the window and with their respective first and second stripes being disposed in contact with the window periphery.

10. The conductor assembly of claim 9, wherein each of the first and second cut segments includes a respective third stripe of the ionomer solution applied onto the respective first surface along the respective length of the respective first surface and running between the respective first and second stripes.

11. The conductor assembly of claim 10, wherein the respective third stripes of the first and second cut segments are self-adhered to each other.

12. The conductor assembly of claim 9, wherein the first and second cut segments are oriented such that the first and second stripes of one of the first and second cut segments are registered with the first and second stripes of the other of the first and second cut segments.

13. The conductor assembly of claim 9, wherein for each of the first and second cut segments the respective first and second stripes are parallel with each other.

14. The conductor assembly of claim 9, wherein the ionomer solution is a perfluorosulfonic acid polymer.

15. The conductor assembly of claim 9, wherein the ionomer solution contains an electrically conductive additive therein.

16. The conductor assembly of claim 9, wherein the respective first and second stripes of the first and second cut segments are disposed in contact with less than an entirety of the window periphery.

17. The conductor assembly of claim 9, wherein each of the first and second cut segments includes one or more respective deposits of the ionomer solution on the respective first surface between the respective first and second stripes, wherein the one or more deposits on one of the first and second cut segments are registered with and self-adhered to the one or more deposits on the other of the first and second cut segments.

18. An apparatus for assembling a conductor assembly for a proton exchange membrane fuel cell, comprising:
an application module configured for applying first, second and third stripes of an adhesive material onto a first surface of a rolled out segment of gas diffusion layer (GDL) material along a length thereof, the rolled out segment having opposed first and second longitudinal edges, wherein the first stripe runs along and is proximate to the first longitudinal edge, the second stripe runs along and is proximate to the second longitudinal edge, and the third stripe runs between the first and second stripes, thereby defining an applied segment;
a cutting module configured for cutting the applied segment so as to form one or more cut segments each having a respective primary surface on which respective portions of the first, second and third stripes are carried; and
a laminating module configured for laminating a generally planar subgasket between two of the cut segments, wherein the subgasket has a window therethrough bounded by a window periphery surrounding the window, and wherein the two cut segments are oriented with their respective primary surfaces facing and covering the window and with their respective portions of the first and second stripes being disposed in contact with the window periphery.

19. The apparatus of claim 18, further comprising:
an unrolling module configured for unrolling a roll of the GDL material to provide the rolled out segment.

20. The apparatus of claim 19, wherein the unrolling module and the application module are configured to cooperate with each other such that the unrolling and the applying are continuous and simultaneous with each other.
